(19) United States
(12) Patent Application Publication
(10) Pub. No.: US 2015/0322701 A1
(43) Pub. Date: Nov. 12, 2015

(54) AC CLAMP

(71) Applicant: Martasz D. Smith, Chicago, IL (US)

(72) Inventor: Martasz D. Smith, Chicago, IL (US)

(21) Appl. No.: 14/275,085

(22) Filed: May 12, 2014

(51) Int. Cl. E05C 19/18

(52) U.S. Cl. CPC E05C 19/188

(57) ABSTRACT

The present invention aims to prevent the theft of air conditioner window units by securing the air conditioner units to windows using a multi-channel clamp adapted to lock the window and air conditioner unit in place. An upward extending channel and a downward extending channel are adapted to slidably accept the top rail of an air conditioner unit and a bottom window sash. The opposing side surfaces of the channel are sufficiently sized to lock the window sash and the air conditioner unit from sliding out of place. The device features a locking thumb screw that locks a window and air conditioning unit in place by forcing the window against the side surface.

This application claims priority of U.S. Provisional Application Ser. No. 61/855,544 filed May 16, 2013, the entire contents of which is incorporated herein by reference thereto.

### BACKGROUND OF THE INVENTION

The present invention relates to an air conditioner (AC) clamp apparatus and the like and particularly to a clamping or locking device for securing air conditioning or ventilating units in window openings. The AC clamp is adapted to be mounted in a window opening and adapted to receive the top rail of a window mounted AC and the bottom sash of a window in two contiguous and oppositely directed channels.

The window AC point is a common entry for burglars. Window mounted AC units for cooling rooms are used in a variety of building types including single family homes, apartment buildings, businesses and schools. Various burglary-deterring techniques have been used to secure AC units at a window base. Some conventional techniques include the use of AC brackets for window attachment, plastic bellows on both sides of the AC unit or building a cage around the unit. In addition, the pre-drilled holes in traditional AC units can be mounted to metal plates that are subsequently secured in the bottom perimeter of the window. These techniques remain problematic in that homes utilizing these techniques remain a target for burglars. AC units can be easily pushed in without much force. For example, the plastic bellows do not secure the AC from side to side, which often causes the unit to wobble and vibrate. In addition, the top rail of most AC units is easily disconnected from the bottom window sash with minor force or shaking The retaining screw is subsequently easy to remove from the pre-drilled hole in the top rail of the AC unit.

Thus, there remains a general need for improved security and stability of window mounted AC units. The AC clamp features a multi-channel configuration, which not only secures the AC unit, but also stabilizes the unit's attachment to the window. Once the window is lowered into the bottom channel and the top rail of the AC unit is placed in the top channel, a locking thumb screw is threaded through the predrilled holes of the AC clamp and the AC top rail. The locking thumb screw is fastened and the AC clamp is locked into place. The AC clamps provides additional stability and security in the top rail of the AC unit making it difficult for a burglar to shake the AC unit out of place. The locking thumb screw can be further tightened in order to adjust to the empty window space in the bottom channel and further prevent any movement of the window.

In an emergency, a user would simply release the locking thumb screw and raise the window. The AC clamp would not require any changes to the standard window or AC construction. In addition, it can be constructed in various sizes to accommodate various window styles.

Further objects and advantages of this invention will become apparent as the following description proceeds and the features of novelty which characterize this invention will be pointed out with particularity in the claims.

### BRIEF SUMMARY OF THE INVENTION

In view of the foregoing disadvantages associated with the various types of methods to secure a window mounted air conditioner (AC) unit, the present invention provides an improved AC clamping system. As such, the general purpose of the present invention is to provide a new and improved window AC unit clamping system that is an improvement over prior art.

The present invention essentially comprises an AC clamp adapted to be mounted in a window opening and adapted to receive the top rail of a window AC unit in a first channel and the bottom sash of a window in a second channel.

A further object of the present invention is to provide an AC clamp further characterized in having at least one locking thumb screw that can be engaged into two cooperating locking holes in the AC clamp, a pre-drilled AC hole and which can be varied in locking intensity therewith.

Another object of the present invention is to provide an AC clamp as characterized which is easy to manufacture and can be produced in various sizes.

In accordance with the present invention there is provided an AC clamp, which has a first channel and a second channel. The first channel is adapted to receive the top rail of a window AC unit. The first channel is formed by integrally connecting a first side surface, an inner surface and an upper horizontal surface. The second channel is adapted to receive the bottom window sash. The second channel is formed by integrally connecting a second side, the inner surface and a lower horizontal surface. The first channel and the second channel are in a contiguous and oppositely directed configuration and are adapted to secure the AC unit in place beneath a window.

The window AC unit is locked into place with a locking thumb screw. The AC clamp is adapted to receive a locking thumb screw in a first locking hole, a pre-drilled hole in the AC unit and a second locking hole centrally aligned on the first side surface and the inner surface of the AC clamp. When engaged in the locking holes, the locking thumb screw is sufficiently sized and constructed to thread through the pre-drilled holes in the AC unit and press against the bottom window sash and to further secure the air conditioner unit to the bottom window sash.

As an alternative embodiment the air conditioner clamp can be constructed with a plurality of locking thumb screws and locking holes. In addition it can be adapted for use with a traditional screw. The air conditioner clamps can also be manufactured in different sizes in order to accommodate variable sizes of air conditioner rails and bottom window sashes.

Additional advantages and features of the present invention will become more apparent when considered in light of the following specification and drawings.

### BRIEF DESCRIPTION OF THE SEVERAL VIEWS OF THE DRAWING

FIG. 1 is an inside view of the AC clamp mounted on a window and showing an attempted burglary.

FIG. 2 is an outside view of the AC clamp.

FIG. 3 is an outside view of the AC clamp being attached to an AC unit.

FIG. 4 is a perspective view of the AC clamp being placed on the AC top rail.

FIG. 5 is a top view of the AC clamp being attached to the AC unit.

FIG. 6 is a perspective view of an AC unit.

FIG. 7 is a perspective view of the AC clamp.

FIG. 8 is a top view of the AC clamp.

FIG. 9 is a bottom view of the AC clamp.

FIG. 10 is a bottom view of the window being open and the locking thumb screw of the AC clamp being completely engaged and tightened against the bottom window sash but the device detached from AC unit.

FIG. 11 is a front view of the AC clamp.

FIG. 12 is a back view of the AC clamp.

FIG. 13 is a right side view of the AC clamp.

FIG. 14 is a left side view of the AC clamp.

FIG. 15 is a perspective right side view of the AC clamp.

FIG. 16 is a perspective left side view of the AC clamp.

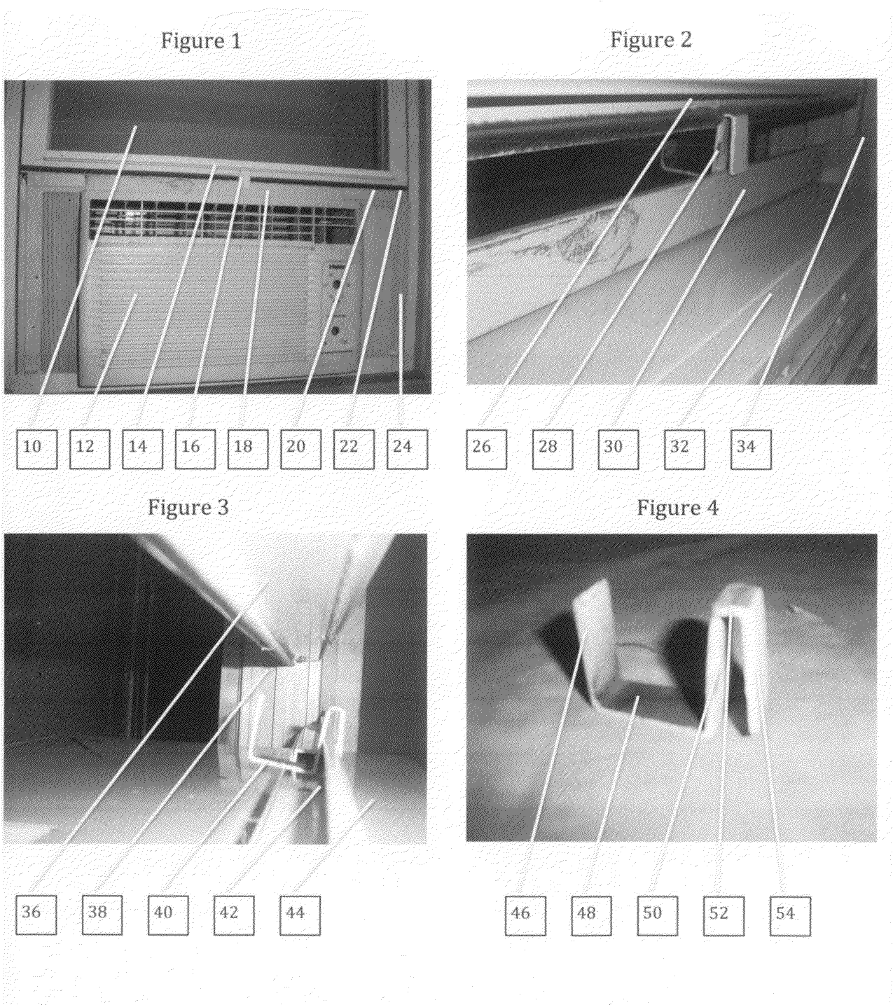

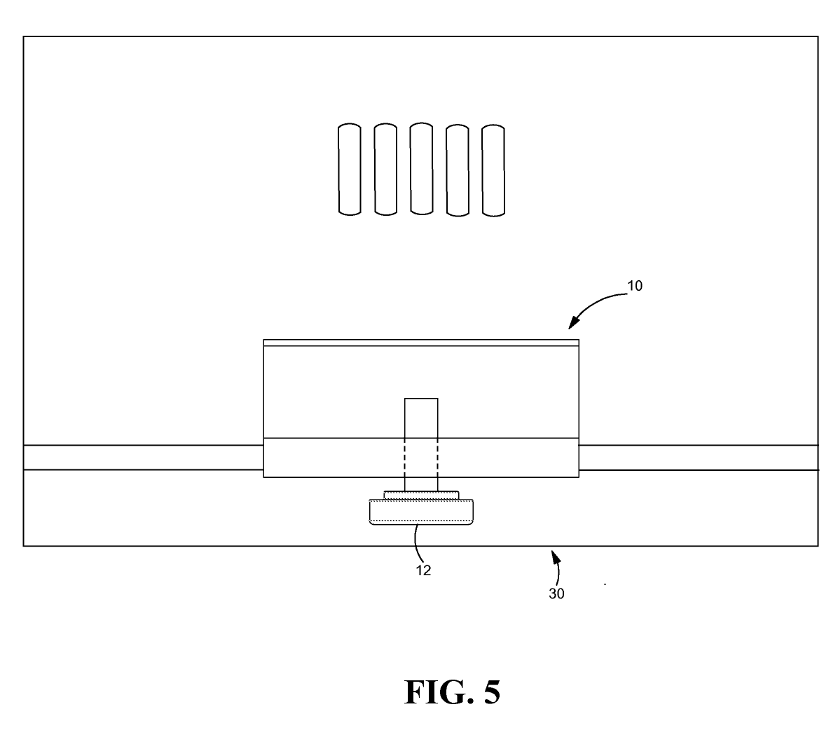

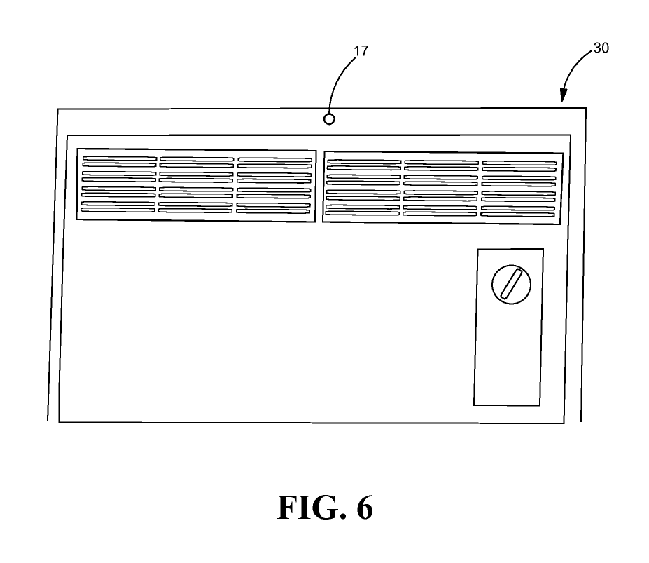

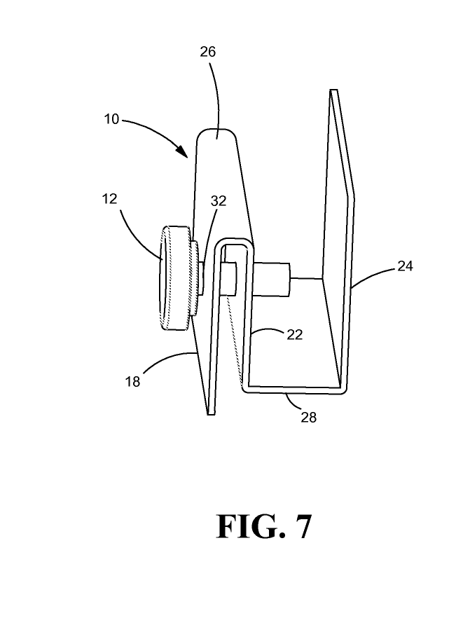

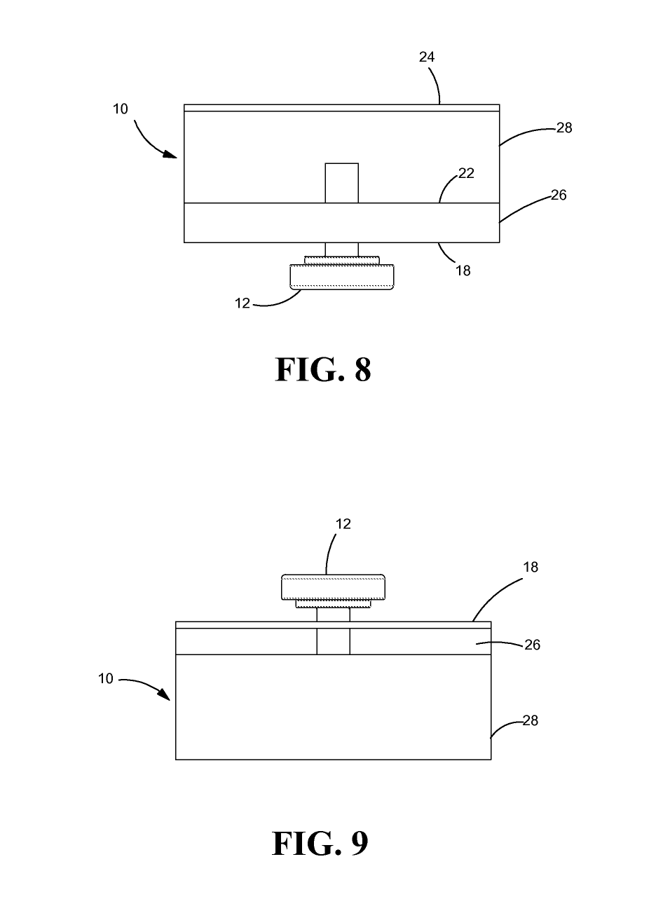

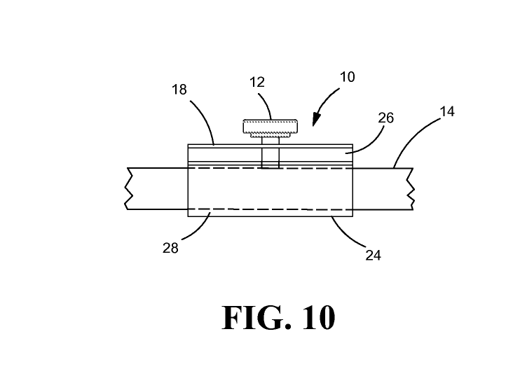

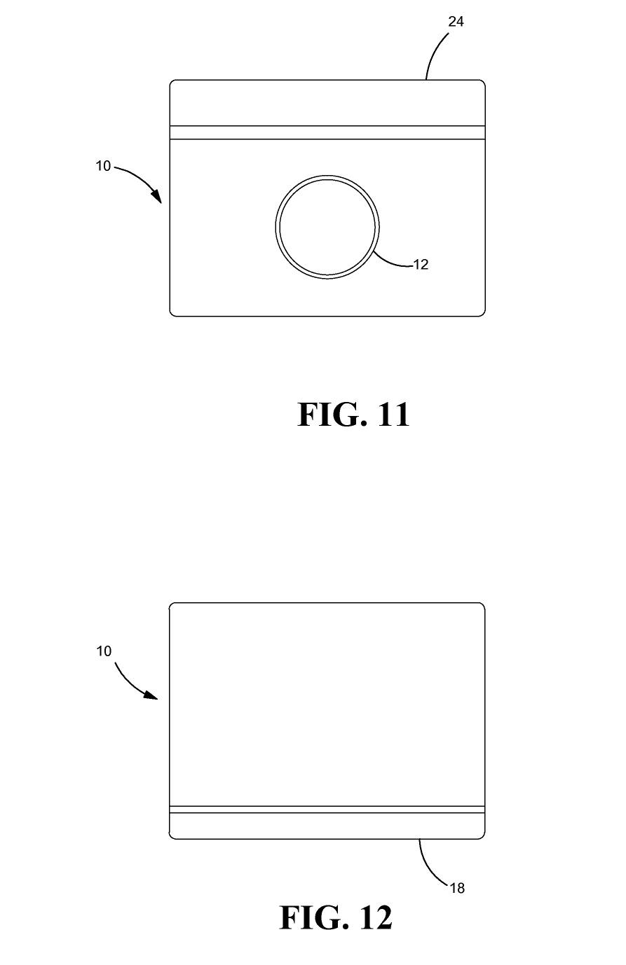

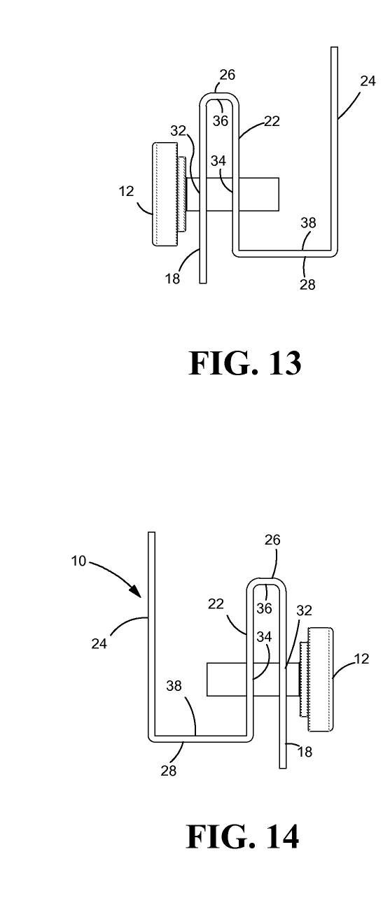

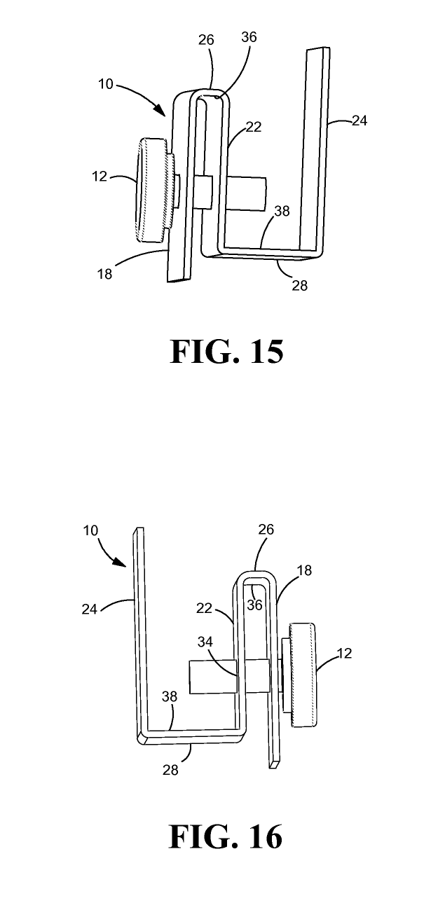

### DETAILED DESCRIPTION OF THE INVENTION

Referring now to the drawings, there is illustrated the preferred embodiment of the air conditioner clamp generally indicated by the numeral 10 and constructed in a accordance with the present invention. The air conditioner clamp 10 is adapted to be mounted in a window 20 opening and adapted to receive the top rail 16 of an air conditioner unit 30 in a first channel 36 and a bottom window sash 14 in a second channel 38.

In general, the air conditioner clamp 10 is adapted to receive a locking thumb screw 12 in a first locking hole 32, a pre-drilled hole 17 in an air conditioner unit 30 and a second locking hole 34. The locking thumb crew 12 is sufficiently sized to press against the bottom window sash 14 and against the second side surface 24 of the air conditioner clamp 10.

Another important feature of the air conditioner clamp 10 is that a lower horizontal surface 28 and an upper horizontal surface 26 slidably receive the top rail of a window air conditioner unit 16 and a bottom window sash 14 and in cooperation seal the gap between the air conditioner unit 30 and the window 20.

Proceeding now to a more detailed description of the elements, the air conditioner clamp 10 comprises a first side surface 18, a second side surface 24, an inner surface 22, an upper horizontal surface 26, a lower horizontal surface 28, a first channel 36, a second channel 38 and a locking thumb screw 12.

The first channel 36 is formed by integrally connecting the first side surface 18, the inner surface 22 and the upper horizontal surface 26. The first channel 36 is adapted to receive the top rail of a window air conditioner unit 16. The second channel 38 is formed by integrally connecting the second side surface 24, the inner surface 22 and the lower horizontal surface 28. The second channel 38 is adapted to receive a bottom window sash 14. The first channel 36 and the second channel 38 are in a contiguous and oppositely directed configuration and are adapted to secure the air conditioner unit 30 in place beneath the window 20. The first side surface 18 and the second side surface 24 have a generally rectangular configuration.

The first locking hole 32 and the second locking hole 34 is centrally located on the first side surface 18 and the inner surface 22. The first side surface 18 extends downward and is adequately sized to receive the top rail of a window air conditioner unit 16 when engaged with the inner surface 22 and locking thumb screw 12.

The second side surface 24 extends upward and is adequately sized to receive a bottom window sash 14. The inner surface 22 cooperates with the second locking holes 34 in order to force said locking thumb screw 12 against the bottom window sash 14 thereby forcing the widow sash 14 to be fixed in a locked position.

The air conditioner clamp 10 of this present invention can be constructed of a durable metal material and is easy to manufacture. The size of the air conditioner clamp 10 can be increased to variable sizes of air conditioner rails and bottom window sashes.

Additional advantages and features of the present invention will become more apparent when considered in light of the following specification and drawings.

What is claimed is:

1. An air conditioner clamp comprising:
a. A first side surface, a second side surface, an inner surface, an upper horizontal surface, a lower horizontal surface, a first channel, a second channel and a locking thumb screw;
b. Said first side surface, said inner surface and said upper horizontal surface being integrally connected to form said first channel;
c. Said second side surface, said inner surface and said lower horizontal surface being integrally connected to form said second channel;
d. Said first channel and said second channel being in a contiguous and oppositely directed configuration;
e. Said locking thumb screw capable of being received by a first locking hole, a pre-drilled hole in said air conditioner unit and a second locking hole;
f. Said first locking hole and said second locking hole being centrally located on said first side surface and said inner side surface respectively.

2. The first side surface of claim 1 wherein said first side surface extends downward.

3. The first side surface of claim 2 wherein said first side surface is sufficiently sized in order to prevent said top rail of said air conditioner from sliding out from beneath said bottom window sash.

4. The second side surface of claim 1 wherein said second side surface extends upward.

5. The second side surface of claim 4 wherein said second side surface is sufficiently sized in order to prevent said bottom window sash from being pushed backward and disconnected from said top rail of said air conditioner.

6. The inner surface of claim 1 wherein said inner surface cooperates with said second locking holes and said pre-drilled holes in order to lock said locking thumb screw against a bottom window sash.

7. The upper horizontal surface of claim 1 wherein said upper horizontal surface has a generally rectangular configuration.

8. Said first channel of claim 1 wherein said first channel is adequately sized in order to receive the top rail of a window air conditioner unit.

9. Said lower horizontal surface of claim 1 wherein said lower horizontal surface has a rectangular configuration.

10. Said second channel of claim 1 wherein said second channel is adequately sized in order to receive said bottom window sash.

11. Said first locking hole and said second locking hole of claim 1 wherein said first locking hole and said second locking hole are threaded and are adapted to receive said locking thumb screw.

12. Said first locking hole and said second locking hole of claim 11 wherein said first locking hole and said second locking hole being substantially aligned in order to receive said locking thumb screw.

13. Said locking thumb screw of claim 1 wherein said locking thumb screw is threaded to mate the threads of said first locking hole, said pre-drilled holes and said second locking hole.

14. Said locking thumb screw of claim 13 wherein said locking thumb screw is sufficiently sized to press said bottom window sash against said second side surface.

15. Said locking thumb screw of claim 1 wherein said locking thumb screw can be constructed from a durable metal material.

16. Said air conditioner clamp of claim 1 wherein said air conditioner clamp being adapted to provide two oppositely directed channels.

17. Said air conditioner clamp of claim 1 wherein said air conditioner clamp can be made of a durable metal material.

18. Said air conditioner clamp of claim 1 wherein the size of said air conditioner clamp could be increased to hold variable sizes of air conditioner rails and bottom window sashes.
